(19) United States
(12) Patent Application Publication
(10) Pub. No.: US 2015/0354793 A1
(43) Pub. Date: Dec. 10, 2015

(54) Attachable Lighting Accessory

(71) Applicant: Techxar Corporation, San Mateo, CA (US)

(72) Inventor: John Huang, San Mateo, CA (US)

(21) Appl. No.: 14/466,675

(22) Filed: Aug. 22, 2014

Related U.S. Application Data
(60) Provisional application No. 62/009,035, filed on Jun. 6, 2014.

(51) Int. Cl. F21V 21/08; F21V 29/70; F21V 5/04; G03B 15/02

(52) U.S. Cl. CPC F21V 21/08; G03B 15/02; F21V 29/70; F21V 5/04

(57) ABSTRACT

The present invention provides a novel attachable lighting accessory, which has never been proposed before for increasing luminance when a mobile electronic device the lighting accessory is attached to is used in a low light environment. By disposing a front lighting device and a back lighting device on the accessory, when a user utilizes a common front camera to build up video conferencing, the front lighting device helps to illuminate the user's face and increase luminance. As for the user using a common back camera to do video or photo shooting, the back lighting device helps to increase luminance of the ambient environment, so that the video or photo shot performs high quality. For optimal viewing, illumination level of the front and back lighting device are adjustable, and a variety of interchangeable optical lens can be further disposed to modify their light beam morphology and characteristics.

### BACKGROUND OF THE INVENTION

1. Field of the Invention

The present invention relates to an attachable accessory, and more particularly to an attachable lighting accessory adapted to a mobile electronic device for increasing luminance.

2. Description of the Prior Art

As the electronic technology developed, a variety of mobile electronic devices are provided in the market today. For expanding their functionalities, the mobile electronic devices nowadays are generally equipped with dual cameras for both front and back photography. For example, since most mobile devices feature a front and a back camera, a user can easily take photos through the front camera of the mobile device, and build up video conferencing through the back camera of the mobile device.

However, it shall be noticed that, when the mobile device is used in the darkness and the video conference is conducted in a low light environment, the variability of ambient light is going to seriously affect the quality of the video conference and thus a clear and fine video-graphy cannot be guaranteed. Also, due to the proximity of the mobile device to the face of the user, over-exposure, under-exposure, or emitting excessive light to the eyes of the user at such close range are common issues occurred in modern times as well.

Therefore, on account of above, it is obvious that there is indeed an urgent need for a novel accessory which can be adapted to different mobile devices both securely and conveniently. The accessory should be easily and quickly attached to and detached from the mobile device for increasing luminance when the mobile device is used in a low light environment so as to obtain superior quality in both photographing and videographing while it is applied.

### SUMMARY OF THE INVENTION

In order to overcome the above-mentioned disadvantages, one major objective in accordance with the present invention is provided for a novel attachable lighting accessory which is adapted to a mobile device. The proposed lighting accessory is able to be attached to the mobile device while in use, and detached from the mobile device while not in use. The attachable lighting accessory of the present invention is aimed to increase luminance when the mobile device is photo-shot, video-shot and/or conducted with a video conference in a low light environment.

For achieving the above mentioned objectives, the proposed lighting accessory of the present invention comprises a base pedestal, at least one connecting portion, disposed on the base pedestal for grabbing onto the mobile device such that adequate securement is provided, a front lighting device, disposed on a front side of the base pedestal; and a back lighting device, disposed on a back side of the base pedestal. According to the present invention, the front lighting device and the back lighting device are designed for giving luminance such that additional ambient light can be provided for photographing and video graphing when the mobile device is used in a low light environment.

According to the embodiment of the present invention, the front lighting device and the back lighting device for example, may comprise lighting emitted diodes.

Moreover, the proposed lighting accessory of the present invention may further comprises at least one button for turning on and turning off the front lighting device and/or the back lighting device. As such, by pressing and holding the button, an user can steadily increase the illumination level of the front lighting device and/or the back lighting device. On the contrary, releasing the button at the appropriate illumination level will cease the increase and maintain the light at such desired level. Then, the user can continue to make up and down adjustments as necessary to ensure proper illumination level for video conferencing.

Furthermore, the proposed lighting accessory of the present invention may further comprises a variety of optional attachable lenses which are disposed upon the front lighting device and/or the back lighting device to modify light beam morphology and characteristics of the front lighting device and/or the back lighting device.

In one embodiment, the optional attachable lens can be a diffuser lens, a cosmetic lens, a backlight lens and an optical magnifier lens. In other embodiments of the present invention, the optional attachable lens can also be other equivalent modifications so as to generate other various lighting conditions.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIGS. 1-3 show various schematic views of an attachable lighting accessory being attached to a mobile device in accordance with one embodiment of the present invention.

FIG. 4 shows a front view of an attachable lighting accessory in accordance with one embodiment of the present invention.

FIG. 5 shows a back view of an attachable lighting accessory in accordance with one embodiment of the present invention.

FIG. 6 shows a top view of an attachable lighting accessory in accordance with one embodiment of the present invention.

FIG. 7 shows a bottom view of an attachable lighting accessory in accordance with one embodiment of the present invention.

FIG. 8 shows a side view of an attachable lighting accessory in accordance with one embodiment of the present invention.

FIGS. 9-10 show various angle views of applying optional attachable lens to the attachable lighting accessory in accordance with one embodiment of the present invention.

FIG. 11 shows a schematic drawing of the applied optional attachable lens when it is a diffuser lens.

FIG. 12 shows a schematic drawing of the applied optional attachable lens when it is a cosmetic lens.

FIG. 13 shows a schematic drawing of the applied optional attachable lens when it is a backlight lens.

FIG. 14 shows a schematic drawing of the applied optional attachable lens when it is an optical magnifier lens.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts. The embodiments described below are illustrated to demonstrate the technical contents and characteristics of the present invention and to enable the persons skilled in the art to understand, make, and use the present invention. However, it shall be noticed that, it is not intended to limit the scope of the present invention. Therefore, any equivalent modification or variation according to the spirit of the present invention is to be also included within the scope of the present invention.

With the introduction of mobile devices having video conferencing capability, there is a need for a quick and easily attachable lighting accessory when the video conference is conducted in a low light environment. Due to the proximity of the mobile device to the face of the user and the variability of ambient light, the present invention discloses an attachable lighting accessory which can be attached to a mobile device while in use, and unattached to the mobile device while not in use. The attachable lighting accessory of the present invention is provided so as to increase luminance when the mobile device is photo-shot, video-shot and/or conducted with a video conference in a low light environment.

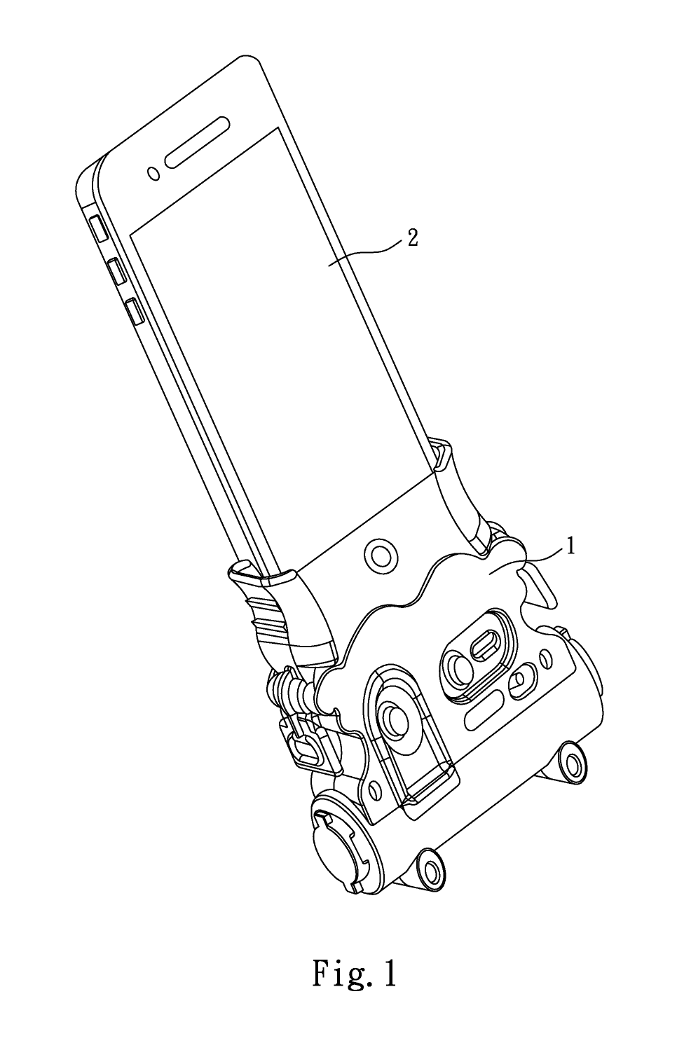

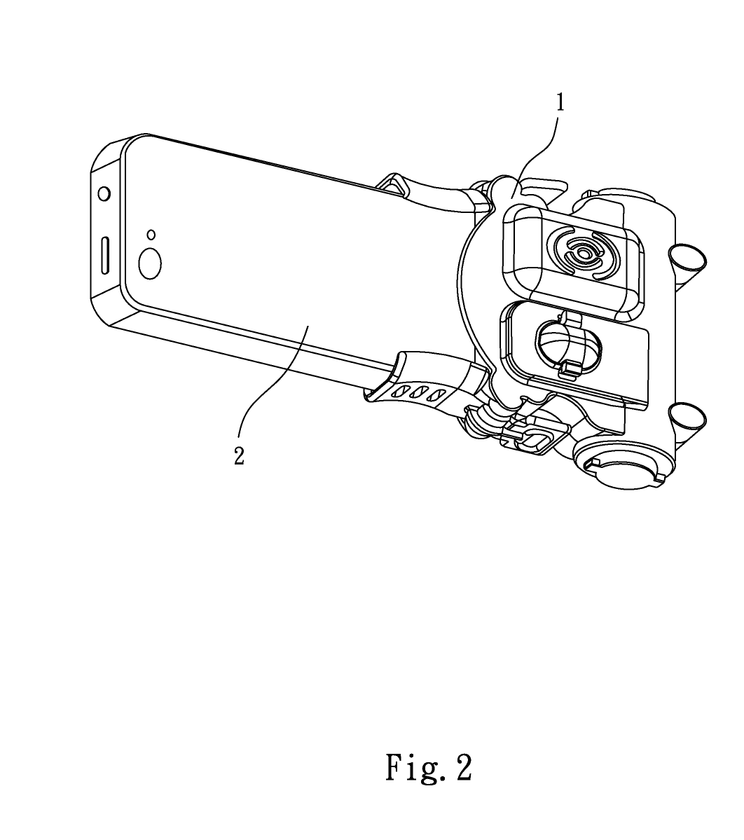

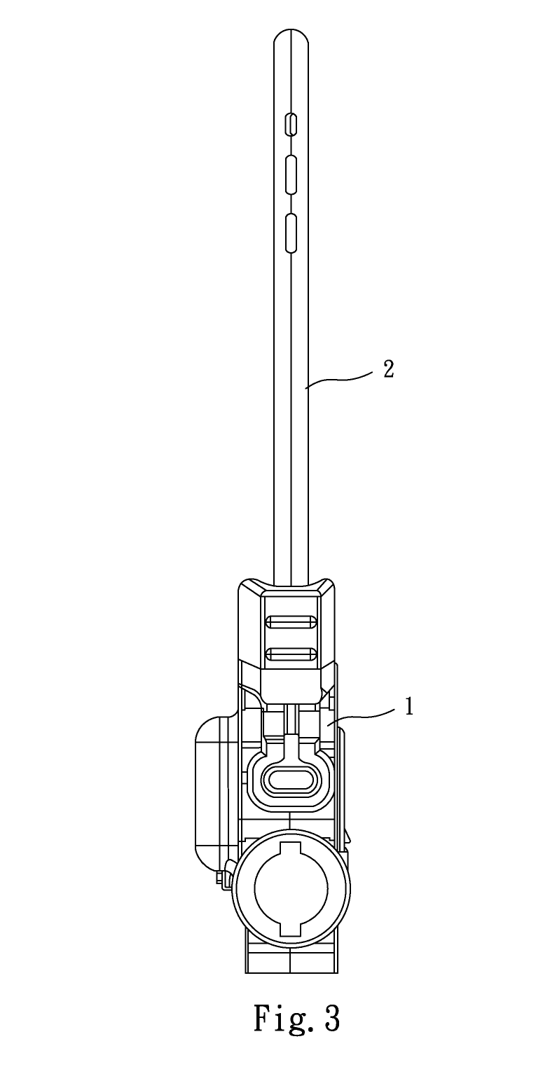

For achieving the above-mentioned objectives, the present invention provides an attachable lighting accessory, which can be attached and/or unattached to a mobile device for increasing luminance when the mobile device is used in a low light environment. In one embodiment, the mobile device can be a mobile phone such as iPhone. In other embodiments, the mobile device may also be a tablet PC or a personal digital assistant of various formats. FIGS. 1-3 show various schematic views of an attachable lighting accessory being attached to a mobile device (i.e. iPhone) in accordance with one embodiment of the present invention. As shown in there figures, it is obvious that the attachable lighting accessory 1 of the present invention provides universality of position in-use and meanwhile guarantees adequate securement to the mobile device 2 it is applied to. However, it should be noticed that the explanatory schematics provided in the present invention are not intended to limit the scope of the present invention. Any equivalent modification or variation, i.e. replacing the iPhone with other mobile phones of different brands or replacing the iPhone with other tablet PC or personal digital assistant according to the spirit of the present invention is to be also included within the scope of the present invention.

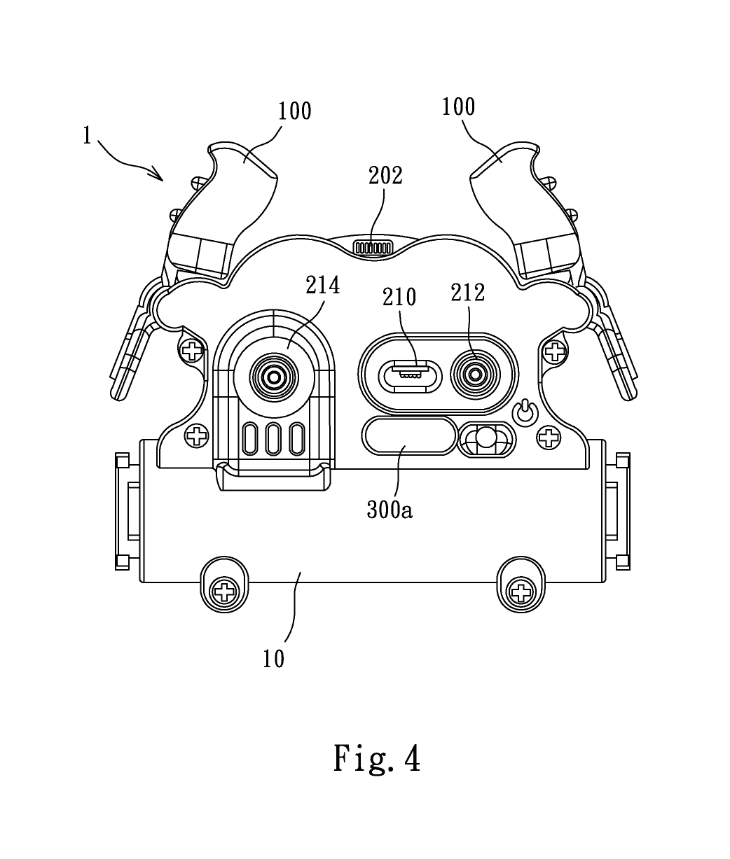

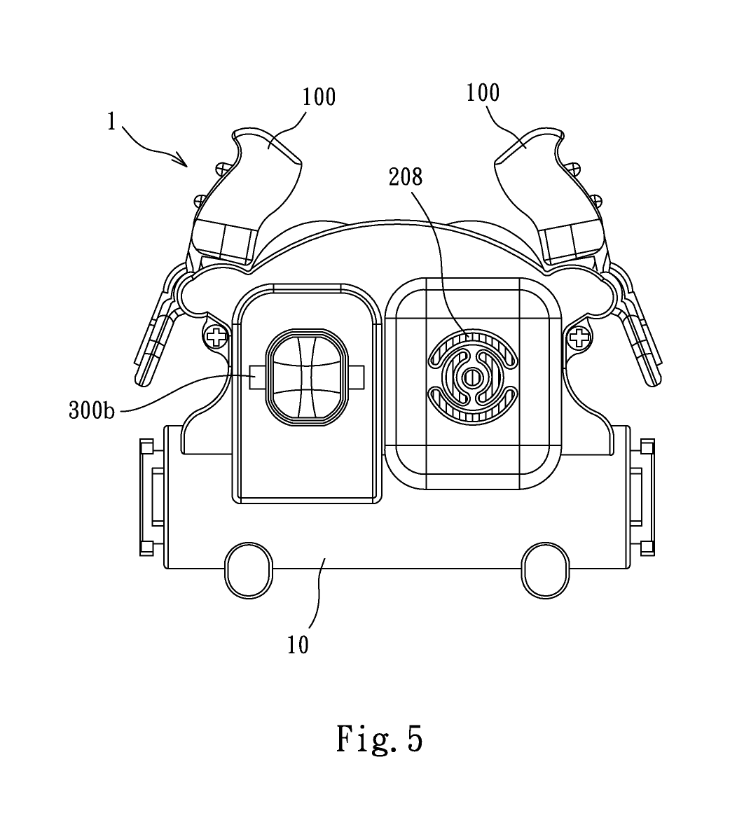

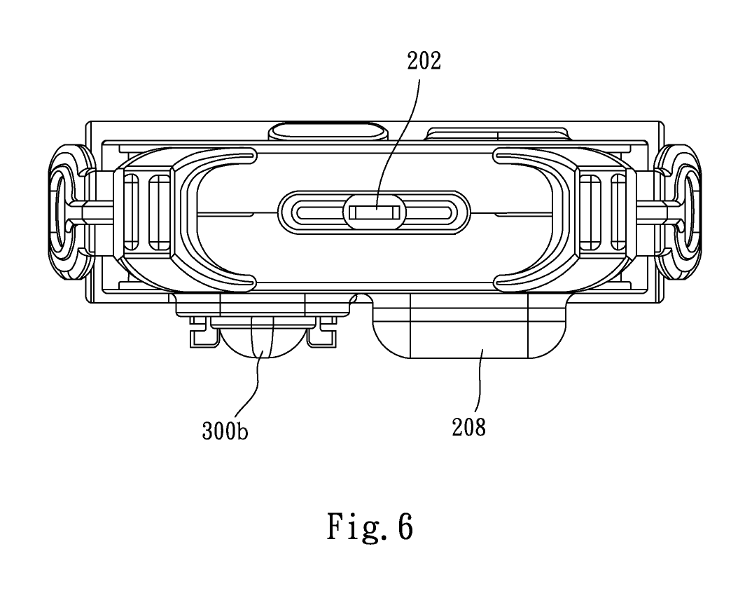

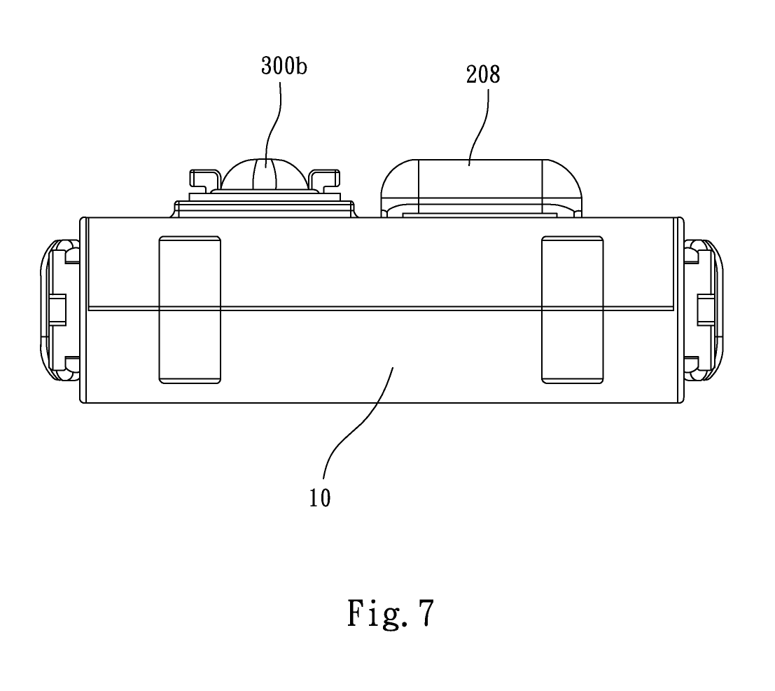

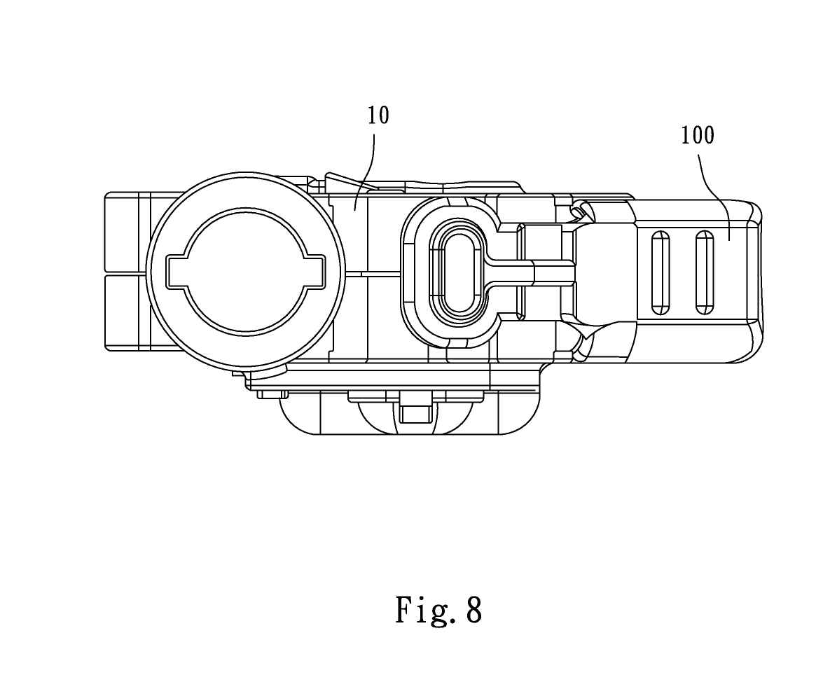

Hereinafter, to explain the details of the proposed attachable lighting accessory 1, please refer to FIG. 4-8, wherein FIG. 4 shows a front view of an attachable lighting accessory in accordance with one embodiment of the present invention; FIG. 5 shows a back view of an attachable lighting accessory in accordance with one embodiment of the present invention; FIG. 6 shows a top view of an attachable lighting accessory in accordance with one embodiment of the present invention; FIG. 7 shows a bottom view of an attachable lighting accessory in accordance with one embodiment of the present invention; and FIG. 8 shows a side view of an attachable lighting accessory in accordance with one embodiment of the present invention.

According to the embodiment of the present invention, the attachable lighting accessory 1 includes a base pedestal 10 and at least one connecting portion 100 which is disposed on the base pedestal 10. The connecting portion 100 is arranged on the base pedestal 10 for grabbing onto the mobile device 2 (shown in FIGS. 1-3) such that adequate securement is provided when mating the attachable lighting accessory 1 to the mobile device 2. For example, the connecting portion 100 can be a pair of arms, a hook or any equivalent modifications for grabbing onto the mobile device it is attached to. In one embodiment, when the connecting portion 100 is a pair of arms, it can be further equipped with certain spring such that the arms are spring loaded. Then, the spring-loaded arms can provide a mechanical force that compresses laterally and/or frontally to the direction of accessory insertion when mating the mobile device, therefore, ensuring much more excellent securement.

According to the embodiment of the present invention, the attachable lighting accessory 1 further comprises a front lighting device 300a disposed on a front side of the base pedestal 10, and a back lighting device 300b disposed on a back side of the base pedestal 10. The front lighting device 300a is used for increasing luminance when the mobile device is conducted with a video conference in a low light environment so as to brighten the user's face. The back lighting device 300b is used for increasing luminance when the mobile device is photo-shot or video-shot in a low light environment so as to additionally provide enough ambient light for photographing and video graphing. According to the embodiment of the present invention, the front lighting device 300a and the back lighting device 300b can, for instance, be a light-emitting-diode (LED) or the like.

A first button 212 and a second button 214 are further disposed on the base pedestal 10 of the attachable lighting accessory 1 for controlling the front lighting device 300a and the back lighting device 300b, for example, turning on and/or off the front lighting device 300a and the back lighting device 300b, respectively. For example, the front lighting device 300a will start to illuminate when the user presses the first button 212, and the back lighting device 300b starts to illuminate when the user presses the second button 214.

Since the attachable lighting accessory 1 of the present invention allows the user to adjust and select a preferred illumination level for optimal viewing without over exposure or under exposure, nor emitting excessive light to the eyes of the user at such close range, the illumination level of the front lighting device 300a and the back lighting device 300 are designed to be adjustable. To be more specific, by pressing and holding the first button 212, the user can steadily increase the illumination level of the front lighting device 300a, and by pressing and holding the second button 214, the user can steadily increase the illumination level of the back lighting device 300b. Therefore, as the brightness is increased, the user can visually confirm its adequacy by looking at the screen of the mobile device until it is sufficient. At this time, releasing the button at the appropriate illumination level will cease the increase and maintain the light at such desired level. The user can continue to make up and down adjustments as necessary to ensure proper illumination level for video conferencing.

As a result, since most mobile devices feature each camera in the front and in the back side respectively, the present invention can further utilize an electronic button mechanism for controlling the direction of illumination. Such dual light switching system allows the user to quickly change illumination between video graphing with the primary back camera or video conferencing with the front camera Moreover, since video graphying and video conferencing are both very power demanding tasks for mobile devices, the direct connection of the attachable lighting accessory 1 to the mobile device 2 allows the simultaneous charging of the mobile device 2 and videographying or video conference by employing a connector 202 disposed on one side of the base pedestal 10. In other words, the attachable lighting accessory 1 of the present invention can be designed to further comprise the connector 202 such that it can be attached to the mobile electronic device via the connector 202. By optionally disposed a lithium battery inside the base pedestal 10 of the accessory 1, the mobile electronic device can thus be charged through the connector 202. Apart from these, the registration in both a lateral plane and a median plane of the mobile electronic device 2 to the accessory 1 can also be implemented by employing the connecting portion 100 along with the connector 202, which not only center the electrical connection between the mobile electronic device 2 and the accessory 1 but to secure them together as well.

As for dissipating the heat generated by the lithium battery, the front lighting device 300a, the back lighting device 300b and/or the mobile electronic device 2, the attachable lighting accessory 1 may further comprise a heat sink 208 configured in the base pedestal 10. Also, a micro universal serial bus (USB) port 210 can be disposed on the base pedestal 10 for connecting to a power source to charge the lithium battery for supplying power source to the front lighting device 300a, the back lighting device 300b and/or the mobile electronic device 2. In one embodiment, the power source may be a power bank, a direct current source, or an alternate current source.

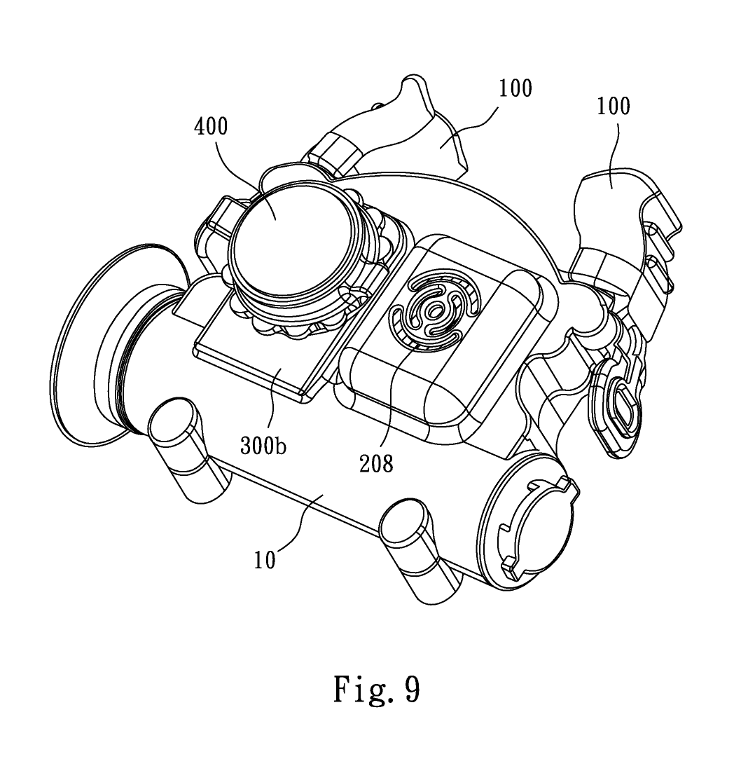

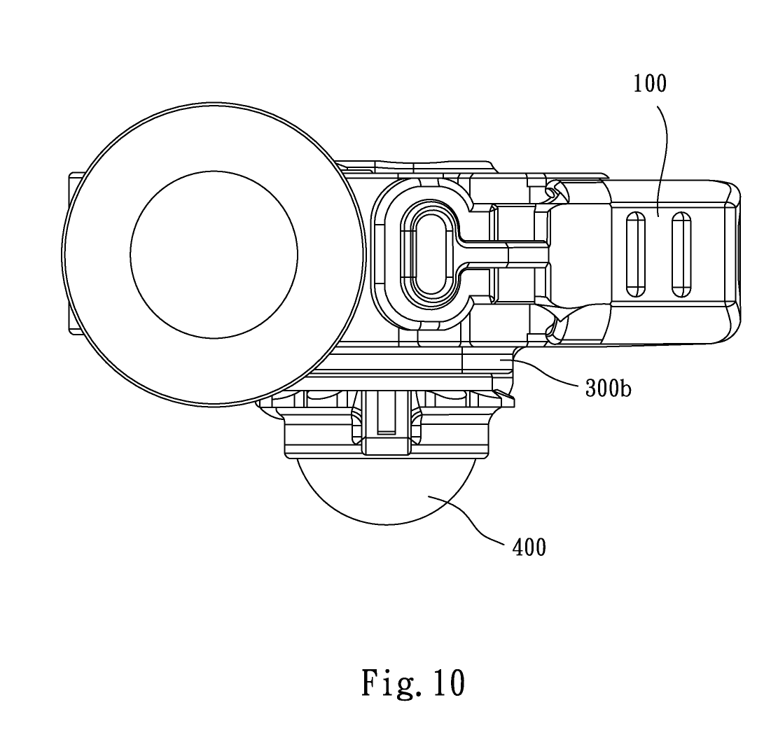

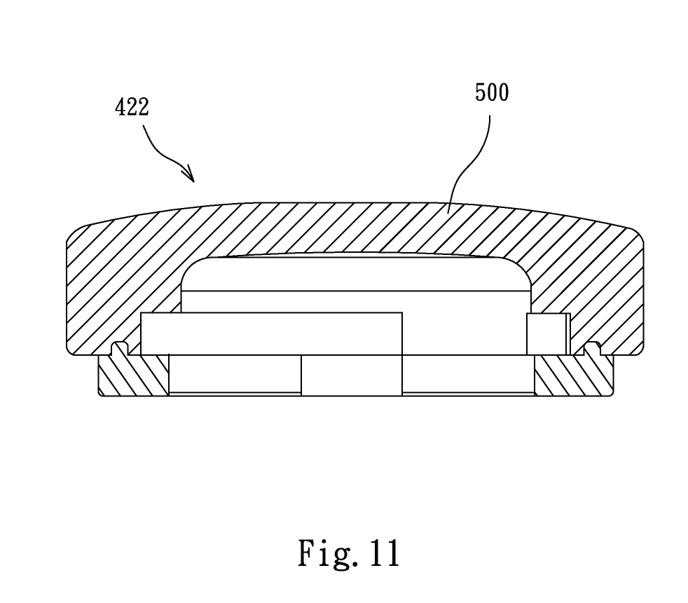

Furthermore, since proper illumination is critical for obtaining superior quality in photographing and videographing, although mobile devices now allow user image processing immediately after a photo is taken, such post processing still cannot modify the original lighting conditions. To solve the issues, the attachable lighting accessory 1 of the present invention is further featured with an interchangeable optical lens system, which provides a variety of optional attachable lenses to modify light beam morphology and characteristics of the front lighting device 300a and/or the back lighting device 300b. Since current mobile devices utilize a built-in LED next to the camera as the flash and video light in order to provide additional illumination, as an externally attached accessory, the proposed attachable lighting accessory 1 significantly increases the illumination level and acts as a socket for attaching such optional optical lens for modifying the light condition. As such, by employing the optional attachable lenses, the user is enabled to take photos and videos not possible previously with such mobile devices or achievable through post processing. Please find figures provided in FIGS. 9-14, wherein FIGS. 9-10 show various angle views of applying optional attachable lens 400 to the attachable lighting accessory in accordance with one embodiment of the present invention; and FIG. 11-14 show various schematic drawings of the applied optional attachable lens, respectively.

As shown in FIGS. 9-10, it can be seen that the optional attachable lens 400 covers the back lighting device 300b, and by doing so, the light condition of the back lighting device 300b can be modified. Similarly, the optional attachable lens 400 can also be disposed upon the front lighting device 300a to cover the front lighting device 300a and to modify the light condition of the front lighting device 300a. The explanatory figures provided as FIGS. 9-10 are only used for showing how the optional attachable lens 400 is configured to be applied to the back lighting device 300b, but not intended to limit the scope of the present invention.

FIG. 11 shows a schematic drawing of the applied optional attachable lens 400 when it is a diffuser lens. The diffuser lens 422 is composed of a vague glass 500. As such, when providing the diffuser lens 422 on top of the front lighting device 300a and/or the back lighting device 300b, the diffuser lens 422 smoothen light beam emitted from the front lighting device 300a and/or the back lighting device 300b to improve object texture. Diffusing the light beam will reduce the hotspots caused by the powerful light beam especially for close range objects, therefore, improve the overall appearance of the photo.

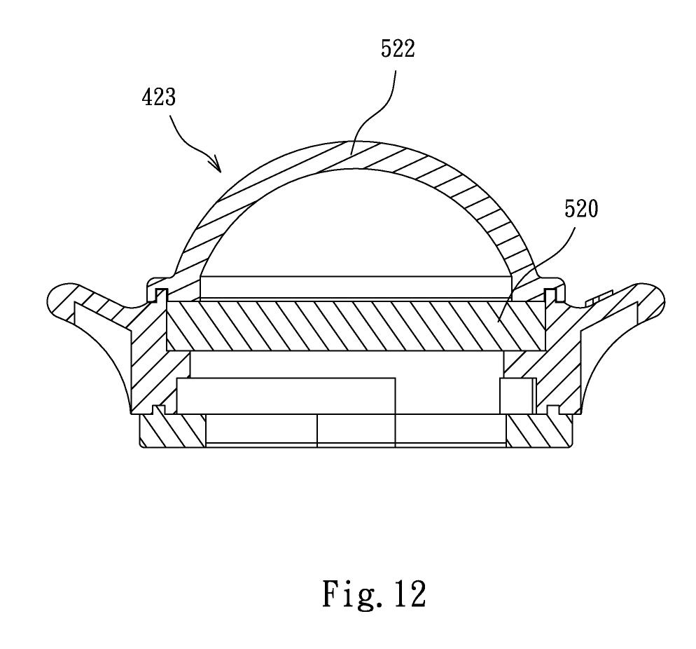

FIG. 12 shows a schematic drawing of the applied optional attachable lens 400 when it is a cosmetic lens. The cosmetic lens 423 is composed of a substrate glass 520 which is skin-colored; and a thin film 522 plating on the substrate glass 520. A golden layer can be optionally further electroplated on the thin film 522. Therefore, when providing the cosmetic lens 423 on top of the front lighting device 300a and/or the back lighting device 300b under sophisticatedly designing a refraction index of the skin-colored glass 520, the cosmetic lens 423 can be used to enhance skin tone color and minimizes facial imperfection. Illuminating a wavelength calibrated light that closely match the skin tone color will blend any imperfections, including wrinkles and blemishes.

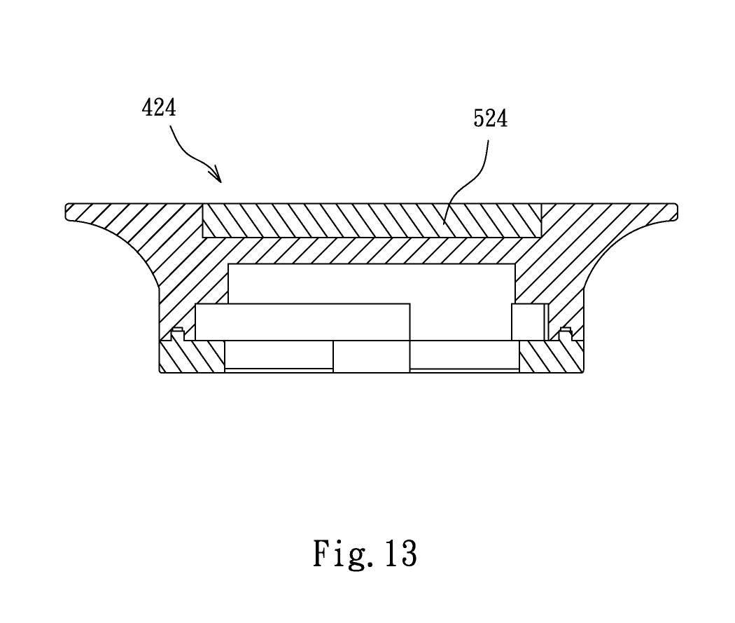

FIG. 13 shows a schematic drawing of the applied optional attachable lens 400 when it is a backlight lens. The backlight lens 424 comprises a dimmer 524 in the center so that the backlight lens 424 reduces light intensity in the center focal area. Effectively, the light is projected around the object in focus. This has the effect of outlining the photographed object.

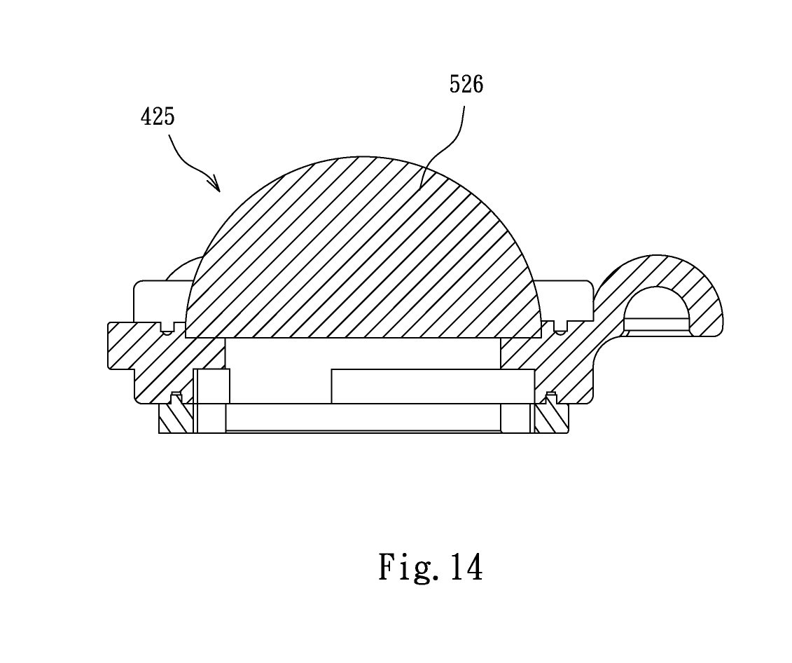

FIG. 14 shows a schematic drawing of the applied optional attachable lens 400 when it is an optical magnifier lens. The optical magnifier lens 425 is composed of a solid glass 526 which is shaped as curves such that it can collimate and focus light into a beam for long distance photographic needs. With an attachment of the optical magnifier lens 425 to the front lighting device 300a and/or the back lighting device 300b, the optical magnifier lens 425 lens can illuminate distant objects in long range photographing for mobile devices.

For the above mentioned optional attachable lens 400, which comprises a variety of the diffuser lens 422, cosmetic lens 423, backlight lens 424 and optical magnifier lens 425, when not in use, they can be stored on either side of the base pedestal 10 of the proposed lighting accessory 1.

As a result, to sum up, a novel attachable lighting accessory has been provided in the present invention for being adapted to different mobile electronic device and for increasing luminance when the mobile electronic device is used in a low light environment. By disposing a front lighting device and a back lighting device on the accessory, when a user utilizes a common front camera to build up video conferencing, the front lighting device helps to illuminate the user's face and increase luminance. While the user utilizes a common back camera to do video or photo shooting, the back lighting device helps to increase luminance of the ambient environment so that the video or photo shot performs high resolution and quality. Moreover, for optimal viewing without over or under exposure, nor emitting excessive light to the eyes of the user at such close range, the illumination level of the front lighting device and the back lighting device are designed to be adjustable and can be steadily increased and/or decreased by the user.

Furthermore, to modify light beam morphology and characteristics, a variety of interchangeable optical lens can be disposed upon the front lighting device and/or the back lighting device to modify its light condition. Various effects, such as smoothing lights, enhancing skin tones, dimming in the center, and focusing beam for long distance can be created. Certainly, other equivalent modifications can also be made to the optional attachable lens for generating various light conditions. The proposed invention is fully described abovementioned but not limited thereto.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. An attachable lighting accessory adapted to a mobile device, comprising:
a base pedestal;
at least one connecting portion, disposed on said base pedestal for grabbing onto said mobile device such that adequate securement is provided;
a front lighting device, disposed on a front side of said base pedestal; and
a back lighting device, disposed on a back side of said base pedestal, wherein said front lighting device and said back lighting device give luminance to provide enough ambient light for photographing and video graphing when said mobile device is used in a low light environment.

2. The attachable lighting accessory adapted to a mobile device of claim 1, wherein said front lighting device or said back lighting device is a light-emitting-diode (LED).

3. The attachable lighting accessory adapted to a mobile device of claim 2, further comprising a first button for turning on and turning off said front lighting device.

4. The attachable lighting accessory adapted to a mobile device of claim 3, wherein by pressing and holding said first button, an illumination level of said front lighting device is adjusted to become steadily increased.

5. The attachable lighting accessory adapted to a mobile device of claim 4, wherein when releasing said first button at an appropriate illumination level, said illumination level of said front lighting device will cease increasing and maintain at such desired level, and an user can continue to make up and down adjustments as necessary to ensure proper illumination level.

6. The attachable lighting accessory adapted to a mobile device of claim 2, further comprising a second button for turning on and turning off said back lighting device.

7. The attachable lighting accessory adapted to a mobile device of claim 6, wherein by pressing and holding said second button, an illumination level of said back lighting device is adjusted to become steadily increased.

8. The attachable lighting accessory adapted to a mobile device of claim 7, wherein when releasing said second button at an appropriate illumination level, said illumination level of said back lighting device will cease increasing and maintain at such desired level, and an user can continue to make up and down adjustments as necessary to ensure proper illumination level.

9. The attachable lighting accessory adapted to a mobile device of claim 1, wherein said front lighting device helps to illuminate an user's face and increase luminance when said user utilizes a common front camera of said mobile device to build up video conferencing.

10. The attachable lighting accessory adapted to a mobile device of claim 1, wherein said back lighting device helps to increase luminance of an ambient environment when an user utilizes a common back camera of said mobile device to conduct video or photo shooting.

11. The attachable lighting accessory adapted to a mobile device of claim 1, further comprising a plurality of optional attachable lens which cover said front lighting device and/or said back lighting device to modify light beam morphology and characteristics of said front lighting device and/or said back lighting device.

12. The attachable lighting accessory adapted to a mobile device of claim 11, wherein said optional attachable lens is a diffuser lens, and said diffuser lens is composed of a vague glass for reducing hotspots.

13. The attachable lighting accessory adapted to a mobile device of claim 11, wherein said optional attachable lens is a cosmetic lens, and said cosmetic lens is composed of a substrate glass which is skin-colored; and a thin film plating on said substrate glass for enhancing skin tone color and minimizing facial imperfection.

14. The attachable lighting accessory adapted to a mobile device of claim 11, wherein said optional attachable lens is a backlight lens, and said backlight lens comprises a dimmer in the center for reducing light intensity in a center focal area.

15. The attachable lighting accessory adapted to a mobile device of claim 11, wherein said optional attachable lens is an optical magnifier lens, and said optical magnifier lens is composed of a solid glass which is shaped as curves for collimating and focusing light into a beam for long distance photographic needs.

16. The attachable lighting accessory adapted to a mobile device of claim 1, wherein said connecting portion is a pair of arms, a hook or any equivalent modifications for grabbing onto said mobile device.

17. The attachable lighting accessory adapted to a mobile device of claim 16, wherein said pair of arms are spring-loaded for providing mechanical force that compresses frontally and laterally to a direction of accessory insertion when mating said mobile device.

18. The attachable lighting accessory adapted to a mobile device of claim 1, further comprising a connector, and said accessory is attached to said mobile device via said connector.

19. The attachable lighting accessory adapted to a mobile device of claim 1, further comprising a heat sink for dissipating heat generated by said front lighting device, said back lighting device or said mobile device.

20. The attachable lighting accessory adapted to a mobile device of claim 1, wherein said mobile device is a mobile phone, tablet PC or personal digital assistant.
